(19) United States
(12) Patent Application Publication
(10) Pub. No.: US 2024/0120118 A1
(43) Pub. Date: Apr. 11, 2024

(54) CORE ASSEMBLY SODIUM FLOW CONTROL SYSTEM

(71) Applicant: TerraPower, LLC, Bellevue, WA (US)

(72) Inventors: Artem Aleshin, Newcastle, WA (US); Joonhyung Choi, Lexington, SC (US); Jason R. Moore, Chapin, SC (US)

(21) Appl. No.: 18/482,704

(22) Filed: Oct. 6, 2023

Related U.S. Application Data
(60) Provisional application No. 63/413,965, filed on Oct. 7, 2022.

(51) Int. Cl. G21C 19/04

(52) U.S. Cl. CPC G21C 19/04; G21C 1/32

(57) ABSTRACT

A masking element with an opening is disposed on the side of a core support structure. A flow stack wall defines a plurality of inlets. At least one inlet aligns with the masking element opening when the flow stack is mated with the masking element. A flow control assembly within the flow stack is configured to restrict flow of fluid within the flow stack.

### GOVERNMENT LICENSE RIGHTS

This invention was made with government support under DOE Cooperative Agreement No. DE-NE0009054 awarded by the U.S. Department of Energy. The government has certain rights in the invention.

### BACKGROUND

In a sodium-cooled fast reactor (“SFR”), the main reactor components are a reactor vessel filled with a liquid sodium coolant and a reactor core. In some cases, an SFR is a once-through fast reactor that runs on subcritical reload fuel that is bred up and burned in situ. The reactor core is immersed in the sodium pool in the reactor vessel. In one design, in the center of the core are a few rods of enriched uranium (U-235), surrounded by rods of depleted uranium (U-238). The U-235 serves as an initiator, kick starting a traveling wave reaction—a slow-moving chain reaction of parallel waves of fission traveling through the uranium rods. These parallel waves initiate in the center of the core, slowly consuming the fuel and generating heat in the core. This mode of operation is sometimes visualized as a reactor in which waves that breed and then burn fissionable material would travel relative to the fuel. However, in many cases, fission plants also include so-called ‘standing wave’ designs in which consumed rods near the center of the reactor core are swapped with unconsumed uranium rods from the periphery of the reactor core as an alternative to propagating the reaction radially outward through static rods.

The sodium coolant is used to remove the heat from the core. The sodium coolant flows through the core assemblies, some of which may be fuel assemblies, by entering a nozzle of the core assembly and flowing about the fuel pins within the core assemblies to remove heat therefrom. A containment vessel surrounds the reactor vessel to prevent loss of sodium coolant in case of an unlikely leak from the reactor vessel. The pumps circulate primary sodium coolant between the reactor core and intermediate heat exchangers located in the pool. These heat exchangers have non-radioactive intermediate sodium coolant on the other side of the heat exchanger. Heated intermediate sodium coolant is circulated to steam generators that generate steam to drive turbines of electrical generators.

In theory, some SFR fission plants require no fuel reprocessing, use depleted or natural uranium as their primary fuel, require only a small amount of enriched uranium at start-up, and never need refueling. This core longevity depends on the size of the initial charge of the uranium and on the fuel burn-up achieved during reactor operation.

The reactor core may contain several types of core assemblies, including core assemblies containing fissile fuel, fertile fuel, reflectors, neutron absorbers, among others. It would be advantageous if these core assemblies could utilize a universal nozzle to allow for efficient manufacturing and sharing of handling equipment, yet still allow the hydrodynamic flow parameters of each core assembly to be to be tuned to allow the desired pressure drop and flow control for each fuel region within the core.

### SUMMARY

In one aspect, the technology relates to an apparatus having: a core support structure; a masking element defining at least one masking element opening disposed at a first height of the masking element, wherein the masking element is disposed on a first side of the core support structure; and a flow stack configured to mate with the masking element, wherein the flow stack includes: a wall defining a plurality of flow stack inlets, wherein at least one of the plurality of flow stack inlets is configured to align with the at least one masking element opening when the flow stack is mated with the masking element; and a flow control assembly disposed within the flow stack, wherein the flow control assembly is configured to restrict a flow of fluid within the flow stack. In an example, the flow control assembly includes a plurality of orifice plates, wherein each plate of the plurality of orifice plates defines at least one orifice therethrough. In another example, the flow stack has a height, and wherein the plurality of orifice plates are disposed at predetermined locations along the height, and wherein at least one of the plurality of flow stack inlets are disposed between each of the plurality of orifice plates. In yet another example, a first flow stack inlet of the plurality of flow stack inlets has a diameter greater than a diameter of a second flow stack inlet of the plurality of flow stack inlets. In still another example, the flow control assembly includes at least one labyrinthine element.

In another example of the above aspect, at least one labyrinthine element is in fluidic communication with at least one of the plurality of flow stack inlets. In an example, the flow control assembly includes a filter. In another example, the filter has a density that varies along a height of the flow stack. In yet another example, the filter includes a plurality of discrete filter elements. In still another example, the masking element is secured to the core support structure.

In another example of the above aspect, the core support structure is configured to receive an inlet guide pin secured to a core assembly in a position substantially aligned with the masking element. In an example, the flow stack is connected to a fuel assembly, and wherein the flow stack is removable from the masking element upon lifting of the fuel assembly. In another example, the masking element includes a plurality of masking elements and wherein the flow stack includes a plurality of flow stacks. In yet another example, a first masking element defines a first masking element opening disposed at a first height of the first masking element, and wherein a second masking element defines a second masking element opening disposed at a second height of the second masking element, wherein the first height is greater than the first height. In some cases, the masking element openings are disposed along a longitudinal axis of the masking element, and the openings may be spaced about the circumference in any suitable configuration. In still another example, the plurality of flow stacks are identical.

In another example of the above aspect, the outer housing defines an outlet at a first end of the outer housing. In an example, the flow stack is disposed within the masking element when the flow stack is mated with the masking element. In another example, the masking element is disposed within the flow stack when the flow stack is mated with the masking element.

In another aspect, the technology relates to an apparatus having: an inlet nozzle defining an inlet opening and an outlet in flow communication with the inlet opening; a duct connected to the inlet nozzle proximate the outlet; a filter element disposed proximate the outlet, wherein a flow into the inlet opening and out of the outlet passes through the filter element prior to entering the duct. In an example, the filter element defines a plurality of openings. In another example, the plurality of openings has a plurality of twisted openings.

### BRIEF DESCRIPTION OF THE DRAWINGS

The accompanying drawings are part of the disclosure and are incorporated into the present specification. The drawings illustrate examples of embodiments of the disclosure and, in conjunction with the description and claims, serve to explain, at least in part, various principles, features, or aspects of the disclosure. Certain embodiments of the disclosure are described more fully below with reference to the accompanying drawings. However, various aspects of the disclosure may be implemented in many different forms and should not be construed as being limited to the implementations set forth herein. Like numbers refer to like, but not necessarily the same or identical, elements throughout.

The following drawing figures, which form a part of this application, are illustrative of described technology and are not meant to limit the scope of the technology as claimed in any manner, which scope shall be based on the claims appended hereto.

FIG. 1 illustrates, in a block diagram form, some of the basic components of a sodium-cooled fast reactor, in accordance with some embodiments.

FIG. 2 is a schematic sectional view of a core of a sodium-cooled fast reactor, in accordance with some embodiments.

FIG. 3 is an exploded view of a core assembly, in accordance with some embodiments.

FIG. 4 is an enlarged sectional view of an inlet nozzle and core support structure interface, in accordance with some embodiments.

FIGS. 5A and 5B are perspective views of components of a sodium flow control system, in accordance with some embodiments.

FIG. 5C is a perspective sectional view of a flow stack of a sodium flow control system, in accordance with some embodiments.

FIGS. 6A and 6B are schematic sectional views of other examples of flow stacks, in accordance with some embodiments.

FIG. 7 is an exploded view of another example of a core assembly, in accordance with some embodiments.

FIGS. 8A and 8B are side and sectional views of a flow stack of another example of a sodium flow control system, in accordance with some embodiments.

FIG. 8C is a side view of a masking element of another example of a sodium flow control system, in accordance with some embodiments.

FIG. 8D is a sectional view of the sodium flow control system of FIGS. 8A-8C, in accordance with some embodiments.

FIGS. 9A and 9B are enlarged partial perspective views of a filtering element for an inlet nozzle of a core assembly, in accordance with some embodiments.

FIGS. 10A and 10B are cutaway views of a segmented sodium flow control system, in accordance with some embodiments.

FIG. 10C illustrates a cutaway view showing a tip plug inserted into an inlet nozzle, in accordance with some embodiments.

FIG. 11A is a perspective partial cutaway view of a nozzle with flow control system, in accordance with some embodiments.

FIG. 11B is a closeup perspective view of a series of orifice sockets or cups located within the nozzle, in accordance with some embodiments.

FIG. 11C is a closeup perspective view of a long, upper orifice socket or cup located within a nozzle, in accordance with some embodiments.

FIG. 11D is a perspective cutaway view illustrating components of a sodium flow control system, in accordance with some embodiments.

FIGS. 12A and 12B perspective partial cutaway views of a nozzle with flow control assemblies, in accordance with some embodiments.

FIG. 12C illustrates a perspective cutaway view of a tip plug secured in an inlet nozzle, in accordance with some embodiments.

### DETAILED DESCRIPTION

The disclosure sets forth example embodiments and, as such, is not intended to limit the scope of embodiments of the disclosure and the appended claims in any way. Embodiments have been described above with the aid of functional building blocks illustrating the implementation of specified functions and relationships thereof. The boundaries of these functional building blocks have been arbitrarily defined herein for the convenience of the description. Alternate boundaries can be defined to the extent that the specified functions and relationships thereof are appropriately performed.

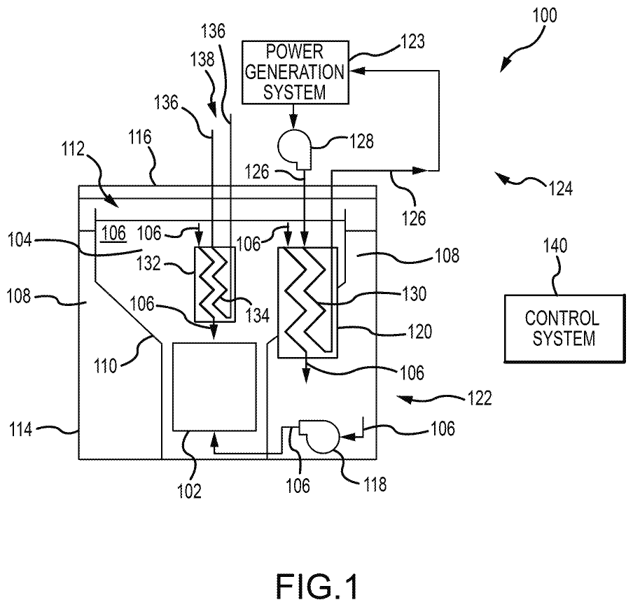

FIG. 1 illustrates, in a block diagram form, some of the basic components of a sodium-cooled fast reactor (SFR) fission plant 100. While an SFR may be used through the description as an example type of reactor technology, it should be appreciated that the concepts presented herein may be equally applicable to other types of reactors. In some cases, the concepts presented in the following description are directly appliable to other forms of sodium-cooled fast reactors (SFRs), such as, for example, traveling wave reactors, modular reactors, micro reactors, among others, and the disclosure and appended claims should not be limited to any specific nuclear reactor, fuel source, coolant type, or reactor architecture.

In general, the SFR fission plant 100 includes a reactor core 102 containing a plurality of fuel assemblies (not shown). The core 102 is disposed within a pool 104 holding a volume of liquid sodium coolant 106. The pool 104 is referred to as a hot pool and has a sodium temperature higher than that of a surrounding cold pool 108 (due to the energy generated by the fuel assemblies in the reactor core 102), which also contains liquid sodium coolant 106. The hot pool 104 is separated from the cold pool 108 by the redan 110. A headspace 112 above the level of the sodium coolant 106 is filled with an inert cover gas, such as argon. The reactor vessel 114 surrounds the reactor core 102, hot pool 104, and cold pool 108, and is sealed with a reactor head 116. The reactor head 116 provides various access points into the interior of the reactor vessel 114.

The size of the reactor core 102 is selected based on a number of factors, including the characteristics of the fuel, desired power generation, available reactor 100 space, and so on. Various examples of an SFR fission plant may be used in low power (around 300 MWe-around 500 MWe), medium power (around 500 MWe-around 1000 MWe), and high power (around 1000 MWe and above) applications, as required or desired. The performance of the reactor 100 may be improved by providing one or more reflectors, not shown, around the core 102 to reflect neutrons back into the core 102. Additionally, fertile and fissile nuclear assemblies are moved (or “shuffled”) within and about the core 102 to control the nuclear reaction occurring therein.

The sodium coolant 106 is circulated within the vessel 114 via a primary sodium coolant pump 118. The primary coolant pump 118 draws sodium coolant 106 from the cold pool 108 and injects it into a plenum below the reactor core 102. The coolant 106 is forced upward through the core and is heated due to the reactions taking place within the reactor core 102. Heated coolant 106 enters an intermediate heat exchanger(s) 120 from the hot pool 104, and exits the intermediate heat exchanger 120 and re-enters the cold pool 108. This primary coolant loop 122 thus circulates sodium coolant 106 entirely within the reactor vessel 114.

The intermediate heat exchanger 120 incorporates a segment of a closed liquid sodium loop that is physically separated from the primary sodium pools 104 and 108 at all times (i.e., intermediate and primary sodium are never co-mingled). The intermediate heat exchanger 120 transfers heat from the primary coolant loop 122 (fully contained within the vessel 114) to an intermediate coolant loop 124 (that is only partially located within the vessel 114). The intermediate heat exchanger 120 passes through the redan 110, thus bridging the hot pool 104 and the cold pool 108 (so as to allow flow of sodium 106 in the primary coolant loop 122 therebetween). In an example, four intermediate heat exchangers 120 are distributed within the vessel 114. Alternatively, two or six intermediate heat exchangers 120 are distributed within the vessel 114.

The intermediate coolant loop 124 circulates sodium coolant 126 that passes through pipes into and out of the vessel 114, via the reactor head 116. An intermediate sodium pump 128 located outside of the reactor vessel 114 circulates the sodium coolant 126 to a power generation system 123. Heat is transferred from the sodium coolant 106 of the primary coolant loop 122 to the sodium coolant 126 of the intermediate coolant loop 124 in the intermediate heat exchanger 120. The sodium coolant 126 of the intermediate coolant loop 124 passes through a plurality of tubes 130 within the intermediate heat exchanger 120. These tubes 130 keep separate the sodium coolant 106 of the primary coolant loop 122 from the sodium coolant 126 of the intermediate coolant loop 124, while transferring heat energy therebetween.

A direct heat exchanger 132 extends into the hot pool 104 and provides cooling to the sodium coolant 106 within the primary coolant loop 122, usually in case of emergency. The direct heat exchanger 132 is configured to allow sodium coolant 106 to enter and exit the heat exchanger 132 from the hot pool 104. The direct heat exchanger 132 has a similar construction to the intermediate heat exchanger 120, where tubes 134 keep separate the NaK (Sodium-Potassium) of the primary coolant loop 122 from the direct heat exchanger coolant (NaK) 136 of a direct reactor coolant loop 138, while transferring heat energy therebetween.

Other ancillary reactor components (both within and outside of the reactor vessel 114) include, but are not limited to, pumps, check valves, shutoff valves, flanges, drain tanks, etc., that are not depicted but would be apparent to a person of skill in the art. Additional penetrations through the reactor head 116 (e.g., a port for the primary coolant pump 118, inert cover gas and inspection ports, sodium processing, and cover gas ports, etc.) are not depicted. A control system 140 is utilized to control and monitor the various components and systems which make up the reactor 100.

Broadly speaking, this disclosure describes configurations that improve the performance of the reactor 100 described in FIG. 1. Specifically, examples, configurations, and arrangements of flow control systems that are utilized to direct sodium into the core assemblies are shown and described in more detail below with reference to the following figures.

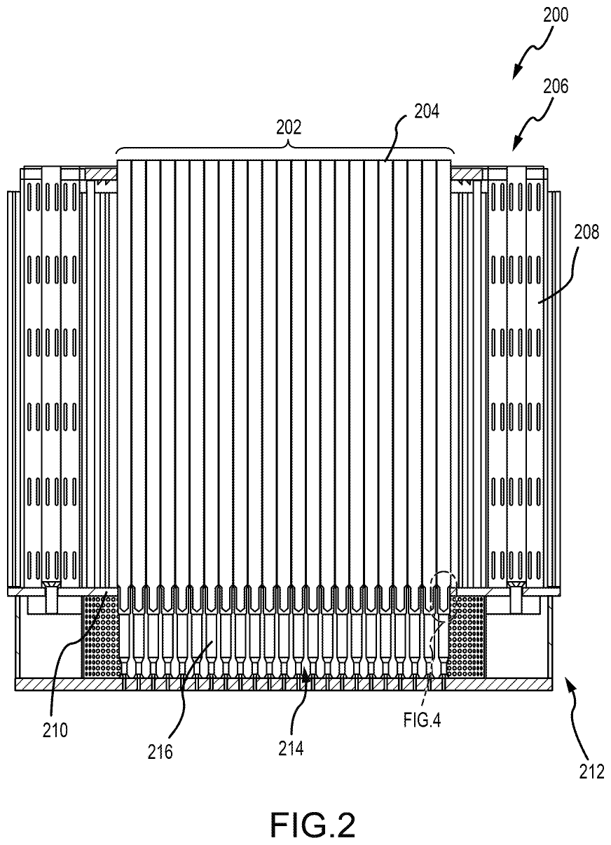

FIG. 2 is a schematic sectional view of a core 200 of an SFR. The core 200 is schematically shown and includes a central core region 202 having a plurality of core assemblies 204. The core assemblies 204 may include fissile nuclear fuel assemblies, fertile nuclear fuel assemblies, shield assemblies, reflector assemblies, control assemblies, and standby shutdown assemblies, or material testing assemblies. In general, the contents of the assemblies (e.g., fissile material, control material, etc.) identifies the particular assembly. The components of the assemblies that hold such material are identical, however. A peripheral core region 206 includes in-vessel storage pots 208. Throughout the life of the core 200, the fissile nuclear fuel assemblies and fertile nuclear fuel assemblies (as well as certain other assemblies) are shuffled between the central core region 202 and the peripheral core region 206. This is performed at various stages of core life as required or desired to initiate, maintain, accelerate, or terminate nuclear reactions or power generation and/or for safety reasons.

The assemblies 204 are received by an upper plate 210 of a core support structure 212 at locations aligned with a masking element 216. Sodium coolant is pumped into a plenum 214 disposed below the upper plate 210 and flows upward into the core assemblies 204, where it is heated by the nuclear reactions taking place within the core 200. Structures that channel the flow of sodium through the core 202 and into the various assemblies are described below.

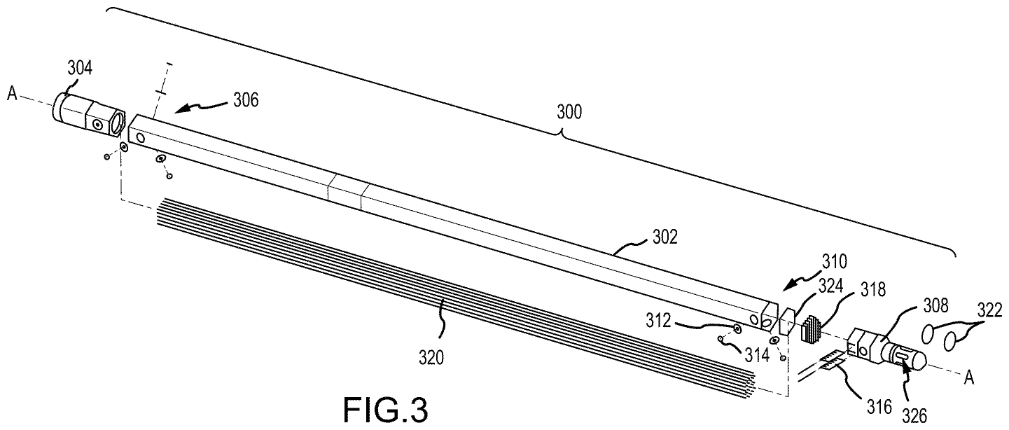

FIG. 3 is an exploded view of a core assembly 300. The assembly 300 includes an elongate duct 302 having a longitudinal axis A. The duct 302 has a hexagonal cross section. A handling socket 304 with an internal flow passage is secured to a first end 306 of the duct 302 and has internal or external features that allow it to be grasped by mechanisms within the reactor vessel to lift, lower, and otherwise move the assembly 300 into, out of, or within the core.

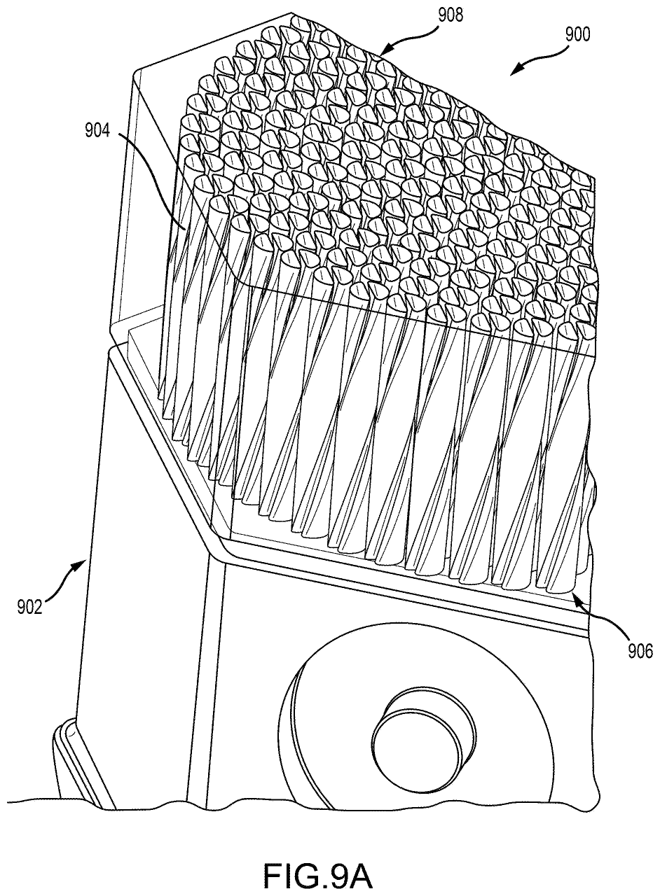

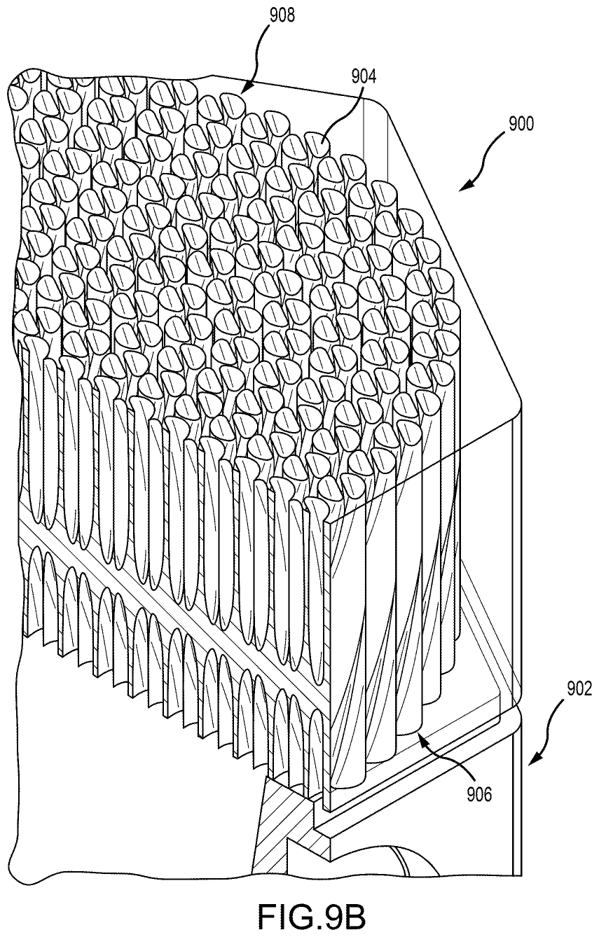

An inlet nozzle 308 is secured to a second end 310 of the duct 302. A plurality of bearing rings 312 and retaining rings 314 are used to attach the handling socket 304 and inlet nozzle 308 to the duct 302. A plurality of lock plates 316 (two in this example) and a plurality of pin strip rails 318 are included proximate an end of the inlet nozzle 308. Together, the lock plates 316 and pin strip rails 318 connect the pin bundle 320 to the inlet nozzle 308. FIGS. 9A and 9B depict an alternative configuration that utilizes a filtering element in lieu of the lock plates 316 and pin strip rails 318. Seal rings 322 and a flow restrictor 324 are also depicted. The nozzle 308 defines a plurality of coolant inlet windows 326 that are in flow communication with an interior flow chamber (not shown) that extends through the nozzle 308. Thus, the windows 326 provide a path for sodium to flow into the nozzle 308 and into the duct 302 to flow around the pin bundle 320 disposed therein. Sodium flow continues out of the handling socket 304.

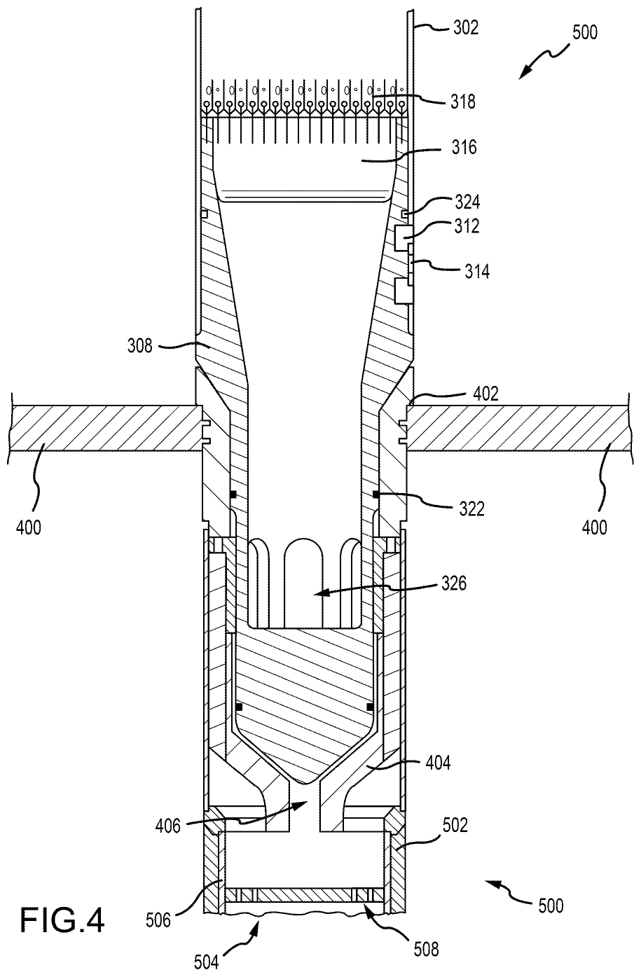

FIG. 4 is a sectional view of an interface between an inlet nozzle 308 and core support structure 400. The inlet nozzle 308 is seated in and engaged with a receptacle 402 of the core support structure 400. A base 404 of the receptacle 402 defines a passage 406 that provides a flow path for sodium to the static reactor sodium pool. The receptacle 402 may extend above the core support structure 400, or may be even therewith. Below the core support structure 400 is a coolant flow control system 500 that includes a masking element 502 and a flow stack 504 disposed therein. In this example, the masking element 502 is in the form of a sleeve. The flow stack 504 includes an outer housing 506 and at least one flow control assembly 516 disposed therein. The flow control system 500 is described in more detail below.

The flow systems described herein utilize a standardized flow stack along with different masking sleeves at various locations below the core support structure. The masking features are secured to or integral with the core support structure while the flow stacks may be integral with a core assembly or discrete therefrom. By utilizing a standardized flow stack, manufacturing costs, inter-assembly differences, and risk of incorrect assembly are decreased because of the standardized parts. A masking sleeve allows each flow stack to be used in any location, over a wide range of flow conditions such as those encountered in an SFR. The flow stack may be integral with a core assembly inlet nozzle or may be fixed within the masking sleeves. The flow stack may include multiple pressure stages and inlets for each stage. The masking sleeve is disposed about the flow stack so as to create selective inlets to the flow stages. This arrangement allows for varying pressure drops according to the selective inlets exposed, which in turn dictates the number of pressure drop stages a flow will encounter. This allows for standardization of fuel assemblies while creating unique flow conditions for different core locations.

For an SFR, this may be advantageous as it allows a core assembly to be installed in, or relocated at any time to (e.g., shuffled to), a different core position while still receiving an appropriate metered flow rate (which can vary from location to location). In examples where the flow stacks are integral with the inlet nozzle, the flow stacks are connected to a removable component (the core assembly). As such, lifetime effects (such as erosion damage) can be examined and mitigated as needed. For a “re-core” operation, where all core assemblies are exchanged for those of a different design, the replacement assemblies do not have to conform to the flow zones of the original core, allowing more flexibility in the design of future cores, if required or desired.

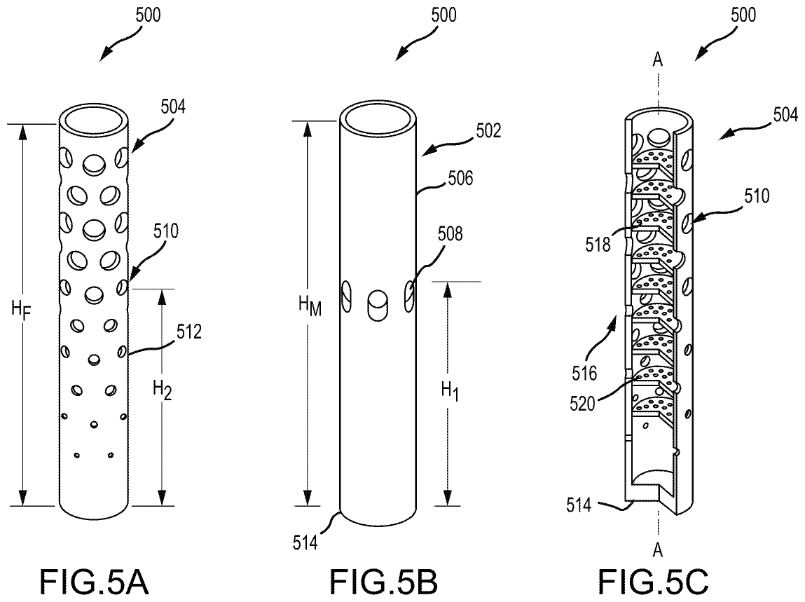

FIGS. 5A and 5B are perspective views of components of a sodium flow control system 500. FIG. 5C is a perspective sectional view of a flow stack 504 of a sodium flow control system 500. FIGS. 5A-5C are described concurrently. The sodium flow control system 500 includes a masking element or sleeve 502, which may be secured to or integral with a core support system (not shown). The masking sleeve 502 includes a generally cylindrical housing 506 that has a total height H_{M}. One or more openings 508 may be disposed about an outer circumference of the housing 506, generally at a predetermined height h₁. In other examples, openings 508 in the masking sleeve may be distributed at different heights of the masking sleeve 502. Depending on the location of a particular masking sleeve opening 508 below the core structure, flow of sodium may enter a flow stack 504 disposed in the masking sleeve 502 at a particular flow stage, as defined by a location of a matching flow stack inlet 510 defined by an outer housing 512 of the flow stack 504. As depicted in FIG. 5A, the flow stack 504 also defines a total height H_{F}, which may be substantially equal to that of the masking sleeve 502. A predetermined height h₂ of a particular flow stack inlet 510 may be such that a particular masking sleeve opening 508 is aligned therewith. As such, the stage at which the sodium enters the flow stack 504 is dictated by the position of the masking sleeve opening 508 of the particular masking sleeve 502 in which the flow stack 504 is disposed.

As can be seen from FIGS. 5A and 5C, a plurality of flow stack inlets 510 are disposed along the height H_{F} of the flow stack 504. The diameters of these flow stack inlets 510 may be different based on their position along the height H_{F} of the flow stack 504, thus affecting the pressure of the sodium coolant as it enters the flow stack 504 at a particular flow stage. In the depicted example, the diameters of the flow stack inlets 510 increase as a distance above the bottom 514 of the flow stack 504 increases. The flow stack 504 includes an internal flow control assembly 516, one example of which is depicted in FIG. 5C. In this example, the flow control assembly 516 includes a plurality of flow stages, each defined at least in part by an orifice plate 518 disposed substantially perpendicular to an axis A of the flow stack 504. The orifice plates 518 are also disposed at predetermined locations along the height H_{F} of the flow stack 504. Each orifice plate 518 defines one or more orifices 520 through which the sodium flows. The diameters of the openings 520 may be different for each orifice plate 518 so as to further control the pressure drop associated therewith. In another example, each orifice plate 518 may instead be formed from a discrete filter that restricts or impedes (to varying degrees, if desired) sodium flow therethrough. These filters may be manufactured of materials similar to those used for the other components of the flow control system 500.

The flow stack inlets 510 are disposed about the housing 512 of the flow stack 504. In the depicted configuration, the flow stack inlets 510 are disposed between adjacent orifice plates 518. Additionally, multiple flow stack inlets 510 are disposed between each orifice plate 518. As such, when the flow stack 504 is disposed in the masking sleeve 502, the flow stack inlets 510 of the flow stack 504 are aligned with associated masking sleeve openings 508. Thus, when flow stacks 504 having identical configurations are used at various locations below the core support structure, the masking sleeves 502 dictate the flow stage in which the sodium enters, based on the position of the masking sleeve openings 508. This enables use of a single flow stack 504 configuration throughout the reactor, while controlling flow as required at various locations within the reactor, based on the particular masking sleeve 502 utilized at each location. Of course, multiple types of flow stacks 504 may be used throughout the reactor core, and may differ based upon position within the core, purpose of the core assembly, or both. As an example, a first flow stack configuration may be used for the fuel assemblies, a second flow stack may be used for the reflector assemblies, and either the first, second, or a third flow stack may be used for the shield assemblies. In some cases, a first flow stack configuration may be used for one core assembly and a second flow stack configuration may be used of a second core assembly. The core assemblies may be the same type of core assembly or may by different types of core assemblies. For instance a first flow stack configuration may be used for a fuel assembly located in a first position within the core and a second flow stack configuration may be used for a fuel assembly located in a second position within the core.

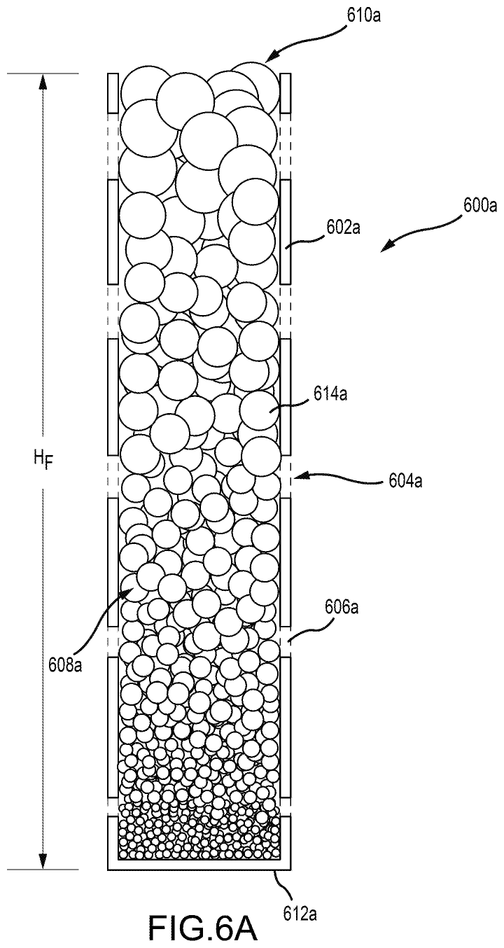

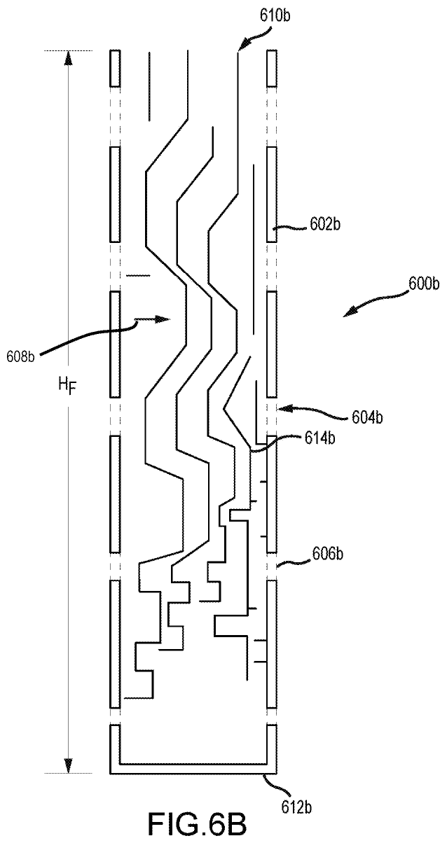

FIGS. 6A and 6B are schematic sectional views of other examples of flow stacks 600a, 600b, respectively. Each flow stack 600a, 600b includes an outer housing 602a, 602b, that may be define a plurality of flow stack inlets 604a, 604b. The diameters, shapes, or other aspects of the flow stack inlets 604a, 604b may vary along the height H_{F} of the flow stack 600a, 600b, as depicted schematically in the figure. Additionally, some or all of the flow stack inlets 604a, 604b may be covered by a mesh or screen 606a, 606b to further restrict flow, retain the flow control assembly 608a, 608b within the outer housing 602a, 602b, or to further reinforce the outer housing 602a, 602b. The depicted flow stack 600a, 600b defines an open top end 610a, 610b and a closed bottom end 612a, 612b, but in other embodiments, flow stacks may include an open bottom end to as to increase sodium flow therethrough.

Notably, masking sleeves used in conjunction with such an open-bottom flow stack may define one or more openings of various sizes therein to control flow into the flow stack via the bottom of the masking sleeve.

In FIG. 6A, the flow control assembly 608a is a flow resistant structure such as a packing bed. The packing bed may be formed from a plurality of discrete packing particles 614a, which may be round, oblong, or have some other shape. The packing bed resists flow of the sodium as is flows upward thorough the flow stack 600a. Resistance to flow may be varied along the height H_{F} of the flow stack 600a by using packing particles 614a of various sizes (e.g., smaller particles proximate the bottom end 612a, with the particle size increasing higher within the flow stack 600a), surface textures, or both. It is known that smaller particles pack more densely, thus producing a higher resistance to flow than a volume containing larger particles. The resistance to flow through the packing bed may be controlled and optimized via known processes. Additionally, sodium flow into the flow stack 600a may be controlled by aligning the desired flow stack inlets 604a with appropriately positioned openings in a masking sleeve (not shown).

In FIG. 6B, the flow control assembly 608b is a flow resistant structure such as a labyrinthine element. The labyrinthine element may be formed from a plurality of discrete fins or plates 614b, which may be oriented parallel, orthogonal to, or skew to the housing 602b. The labyrinthine element is in fluidic communication with the flow stack inlets 604b and resists flow of the sodium as is flows upward thorough the flow stack 600b. Resistance to flow may be varied along the height H_{F} of the flow stack 600b by using discrete fins or plates 614b spaced apart at various distances (e.g., smaller spacing proximate the bottom end 612b, with the spacing increasing higher within the flow stack 600b). It is known that smaller spacing between elements produces a higher resistance to flow than larger spacing. The resistance to flow through the packing bed may be controlled and optimized via known processes. Additionally, sodium flow into the flow stack 600b may be controlled by aligning the desired flow stack inlets 604b with appropriately positioned openings in a masking sleeve (not shown). In another example, the flow control assembly 608b may be a metal wool or filter or other material packed into the flow stack 600b. In examples, density (and thereafter resistance to flow) of the meta wool or filter may vary along the height H_{F} of the flow stack 600b.

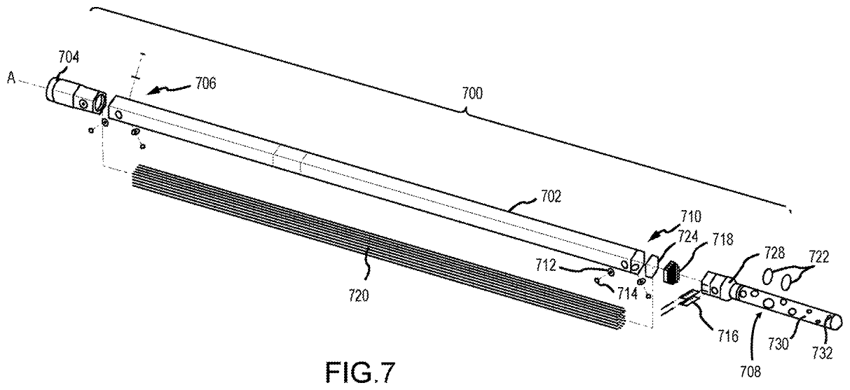

FIG. 7 is an exploded view of another example of a core assembly 700. The assembly 700 includes an elongate duct 702 having an axis A. The duct 702 has a hexagonal cross section. A handling socket 704 with an internal flow passage is secured to a first end 706 of the duct 702 and has internal or external features that allow it to be grasped by mechanisms within the reactor vessel to lift, lower, and otherwise move the assembly 700 into, out of, or within the core. An inlet nozzle 708 is secured to a second end 710 of the duct 702. A plurality of bearing rings 712 and retaining rings 714 are used to attach the handling socket 704 and a flow stack nozzle 728 to the duct 702. A plurality of lock plates 716 (two in this example) and a plurality of pin strip rails 718 are included proximate an end of the flow stack nozzle 728. Together, the lock plates 716 and pin strip rails 718 connect the pin bundle 720 to the flow stack nozzle 728. Seal rings 722 and a flow restrictor 724 are also depicted.

The depicted core assembly 700 differs from the core assembly depicted in FIG. 3 in that it includes a flow stack nozzle 728, instead of the inlet nozzle 308. As such, the flow stack nozzle 728 incorporates a flow stack 730 into the core assembly 700. The flow stack nozzle 728 defines a plurality of flow stack inlets 732 that are in flow communication with a flow control assembly (not shown) disposed therein. The flow control assembly may be one of the configurations depicted herein. Thus, the flow stack inlets 732 provide a path for sodium flow into the flow stack nozzle 728 and into the duct 702 to flow around the pin bundle 720 disposed therein. Sodium flow then continues out of the handling socket 704. Unlike the examples depicted in FIGS. 3-5C, the flow stack nozzle 728 is movable with the core assembly 700 when the core assembly 700 is moved within the core. In such a configuration, flow through the flow stack nozzle 728 and the core assembly 700 is controlled based on the core assembly's 700 position within the core due to the masking sleeve (not shown) into which the flow stack nozzle 728 is inserted.

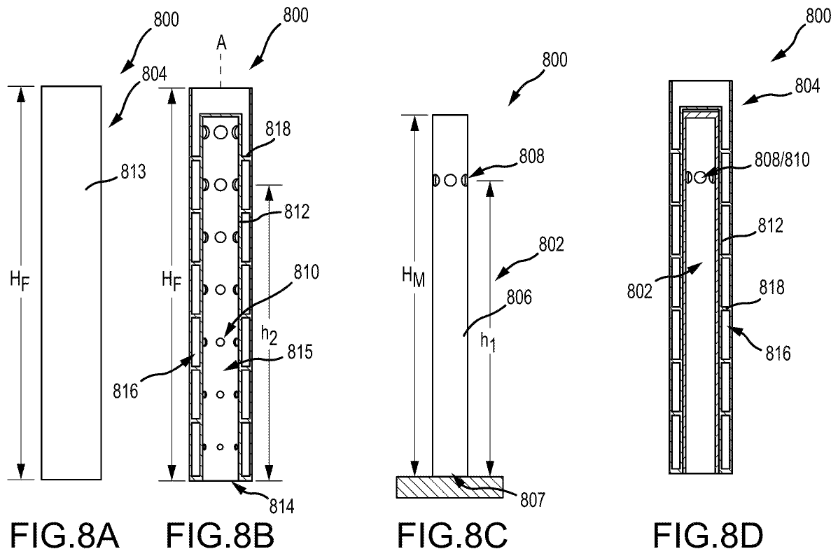

FIGS. 8A and 8B are side and sectional views of a flow stack 804, and FIG. 8C is a side view of a masking element 802 of another example of a sodium flow control system 800. FIG. 8D is a sectional view of the sodium flow control system 800 of FIGS. 8A-8C. FIGS. 8A-8D are described concurrently. As an alternative to the flow control system of FIGS. 5A-5C, the depicted flow control system 800 is configured such that the masking element 802 fits within the flow stack 804. As such, the masking element 802 acts as a flow distribution boss. The sodium flow control system 800 includes a masking element 802, which may be secured to or integral with a core support system (not shown). The masking element 802 includes a generally cylindrical housing 806 that has a total height H_{M}. One or more openings 808 may be disposed about an outer circumference of the housing 806, generally at a predetermined height h₁. In other examples, openings 808 in the masking element 802 may be distributed at different heights of the masking element 802. Sodium flow enters the masking element 802 through a bottom inlet 807. Depending on the location of a particular masking element opening 808 below the core structure, flow of sodium is upward through the masking element 802 and enters a flow stack 804 disposed about the masking element 802 at a particular flow stage, as defined by a location of a matching flow stack inlet 810 defined by an inner wall 812 of the flow stack 804. In this example, an outer housing 813 of the flow stack 804 includes no openings. As depicted in FIGS. 8A and 8B, the flow stack 804 also defines a total height H_{F}, which is generally greater than that of the masking element 802, which is received within a space 815 defined by the inner wall 812. A predetermined height h₂ of a particular flow stack inlet 810 may be such that a particular masking element opening 808 is aligned therewith. As such, the stage at which the sodium enters the flow stack 804 is dictated by the position of the masking element opening 808 of the particular masking element 802 around which the flow stack 804 is disposed.

As can be seen from FIG. 8B, a plurality of flow stack inlets 810 are disposed along the height H_{F} of the flow stack 804. The diameters of these flow stack inlets 810 may be different based on their position along the height H_{F} of the flow stack 804, thus affecting the pressure of the sodium coolant as it enters the flow stack 804 at a particular flow stage. In the depicted example, the diameters of the flow stack inlets 810 increase as a distance above the bottom 814 of the flow stack 804 increases. The flow stack 804 includes an internal flow control assembly 816, one example of which is depicted in FIGS. 8B and 8D. In this example, the flow control assembly 816 includes a plurality of flow stages, each defined at least in part by an orifice plate 818 disposed substantially perpendicular to an axis A of the flow stack 804. The orifice plates 818 are also disposed at predetermined locations along the height H_{F} of the flow stack 804. Each orifice plate 818 defines one or more orifices (not shown) through which the sodium flows. The diameters of the openings may be different for each orifice plate 818 so as to further control the pressure drop associated therewith. In another example, each orifice plate 818 may instead be formed from a discrete filter that restricts or impedes (to varying degrees, if desired) sodium flow therethrough. These filters may be manufactured of materials similar to those used for the other components of the flow control system 800.

The flow stack inlets 810 are disposed along the inner wall 812 of the flow stack 804. In the depicted configuration, the flow stack inlets 810 are disposed between adjacent orifice plates 818. Additionally, multiple flow stack inlets 810 are disposed between each orifice plate 818. As such, when the flow stack 804 is disposed about the masking element 802, as depicted in FIG. 8D, the flow stack inlets 810 of the flow stack 804 are aligned with associated masking element openings 808 (in FIG. 8D, flow stack inlets 810 not aligned with masking element openings 808 are not depicted for clarity). Thus, when flow stacks 804 having identical configurations are used at various locations below the core support structure, the masking elements 802 dictate the flow stage in which the sodium enters, based on the position of the masking element openings 808. This enables use of a single flow stack 804 configuration throughout the reactor, while controlling flow as required at various locations within the reactor, based on the particular masking element 802 utilized at each location.

FIGS. 9A and 9B are enlarged partial perspective views of a filtering element 900 for an inlet nozzle 902 of a core assembly. In the core assemblies depicted above in FIGS. 3, 4, and 7 depict a plurality of lock plates and pin strip rails that connect the pin bundle within the core assembly to the inlet nozzle. While this configuration displays certain advantages, FIGS. 9A and 9B depict a filtering element 900 that may replace the lock plates and pin strips. The filtering element 900 may be utilized to capture debris that may flow through the inlet nozzle 902, so as to prevent damage to the individual pins of the fuel bundle. Such debris may include small, wire-type debris that can pass through the inlet nozzle and that may have enough mass to damage the fuel pins by fretting wear. The filter element 900 is formed of a solid plate having a plurality of twisted openings 904 therethrough. Each opening 904 defines a substantially semi-circular profile. The twisted configuration of the openings 904 eliminates a line-of-sight through each opening 904 from a lower extent 906 of each the filter element 900 to an upper extent 908 thereof. This configuration can capture debris without causing a significant increase in pressure drop, which may compromise cooling of the fuel pins. The complex shapes of the individual openings 904 of the filtering element 900 may be manufactured by using additive manufacturing technology (e.g., 3D printing). Thus, sodium flow that enters the inlet nozzle 902 (e.g., via an inlet opening), flows out of the outlet of the inlet nozzle and through the filtering element 900. Thereafter, the sodium flow passes into the duct and around the individual pins of the pin bundle therein.

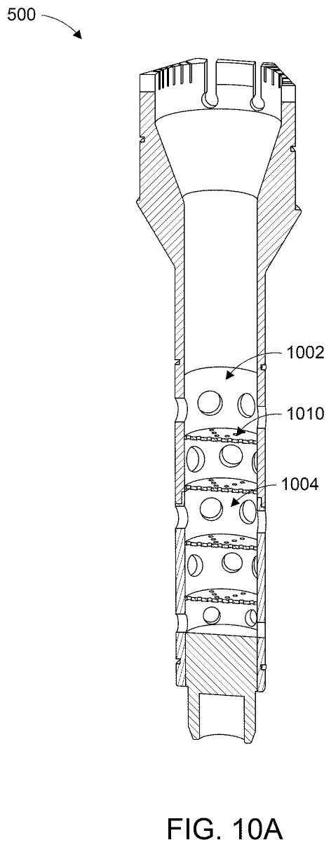

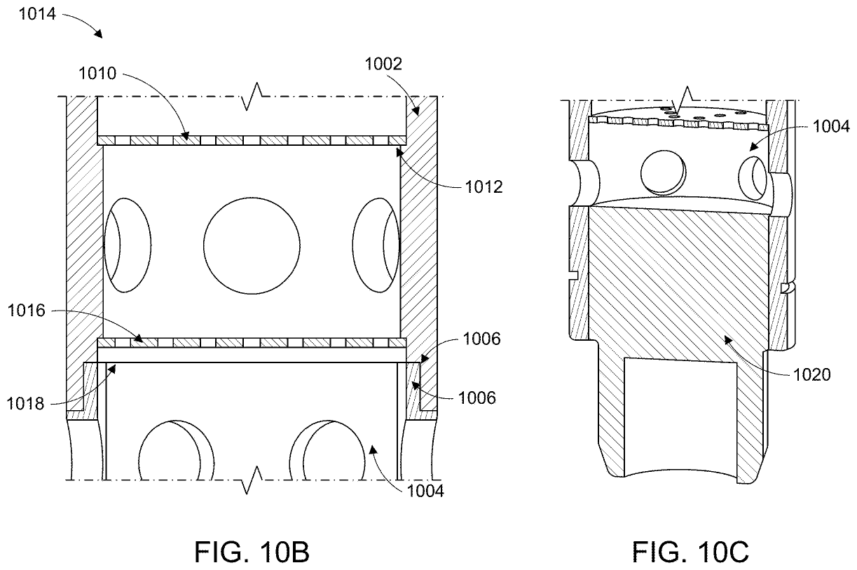

FIGS. 10A, 10B, and 10C illustrate cutaway views of a segmented sodium flow control system 500. In some cases, the sodium flow control device will be subject to neutron irradiation which has been shown to affect weld strength. In some cases, the components may be formed with threaded ends and thereafter screwed together for assembly. As illustrated, the sodium flow control system 500 may have a first segment 1002 and a second segment 1004. The segments 1002, 1004 may be manufactured as separate components and then assembled together. In some cases, a first segment may have a female end with inner threads 1006. A second segment may have a male end with outer threads 1008 that cooperate with the inner threads 1006 to facilitate coupling of the first segments 1002 to the second segment 1004. In like manner, additional segments may be attached to form a grouping of segments of any desired length.

During manufacture of the segments, in some cases, a segment may have an orifice plate 1010 disposed therein. The orifice plate may be formed through any suitable process and coupled to the segment. For instance, one or more orifice plates may be integrally formed within a segment such as by an additive manufacturing method or a suitable material removal manufacturing method. In some cases, an orifice plate 1010 may be formed separately and subsequently attached to a segment, such as by welding, for example. In some cases, a segment 1002 may be formed with a shelf 1012 that an orifice plate 1010 rests on for proper placement of the orifice plate 1010 within the segment 1002. A segment 1002 may comprise one or more orifice plates 1010, as desired. In some embodiments, a segment 1002 may have a first orifice plate 1010 inserted into a first side of the segment 1014 and a second orifice plate 1016 inserted into a second side of the segment 1018.

In some examples, as segments 1002 are coupled together, such as by a threaded engagement, the segments may be further secured together by another fastening means, such as welding, pinning, brazing, adhering, or otherwise.

As shown in FIG. 10C, in some cases, a tip plug 1020 may be inserted into the lowermost segment and affixed thereto. In some cases, the tip plug 1020 may be coupled to the segment 1004 through any suitable mechanism, such as threading, welding, pinning, friction, adhering, or combination of coupling techniques. In some cases, the tip plug is designed to reside in a low fluence region of the nuclear reactor and welding may be a suitable technique for securing the tip plug 1020 to the segment 1004.

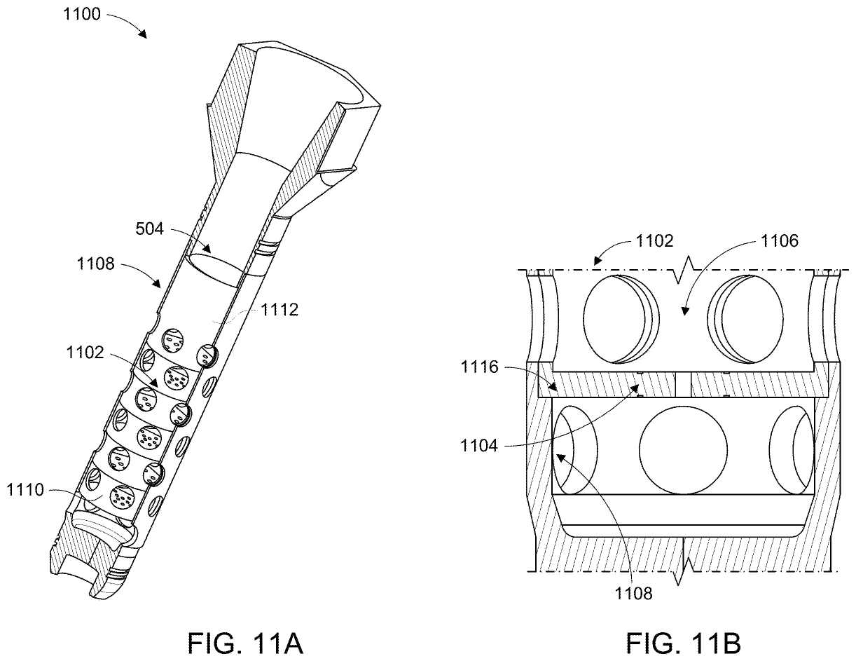

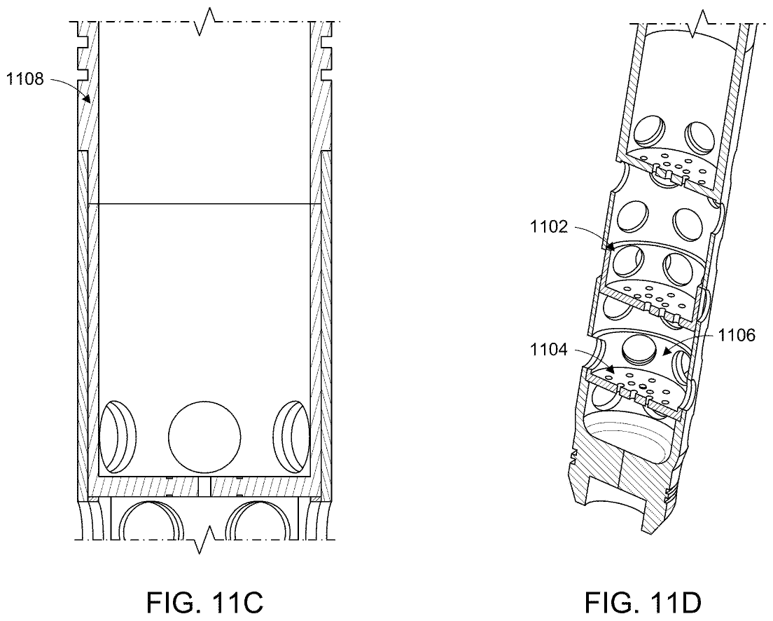

FIGS. 11A, 11B, 11C, and 11D illustrate alternative embodiments and components of a flow control system 1100. According to some embodiments, an orifice socket 1102 is a cup-shaped device having a circular bottom 1104 and a sidewall 1106 extending up from the bottom 1104. The bottom 1104 may be formed with one or more holes to allow primary coolant to flow therethrough. Similar to other embodiments described herein, the holes in the bottom 1104 of the orifice sockets 1102 may be sized and distributed to allow for a predetermined pressure drop across each orifice socket 1102 or across the entire flow stack 504. The sidewall 1106 may also have holes formed therein that may align with one or more holes in the inlet nozzle 1108 to allow sodium coolant to enter the flow stage defined by each respective orifice socket 1102. A series of orifice sockets 1102 may be stacked within the inlet nozzle 1108 to control the pressure drop of the flow stack 504 and to provide one or more flow stages where coolant can enter the flow stack 504. The height of the sidewall 1106 may be configured to control the spacing between stacked orifice sockets 1102, such that each orifice socket 1102 defines a flow stage and each orifice socket bottom 1104 is spaced from adjacent orifice socket bottom 1104 a desired distance. In some examples, orifice sockets 1102 having different heights may be used to create flow stages having different volumes. For example, one or more first orifice sockets 1110 each having a first height may be stacked to create one or more flow stages. A second orifice socket 1112 having a second height larger than the first height may likewise be placed in the stack to create a flow stage having a larger volume than a flow stage volume created by the first orifice sockets. The orifice sockets 1102 may be arranged in any suitable configuration to create the flow characteristics desired by the flow control system. In some cases, the inlet nozzle 1108 is configured to receive the orifice sockets 1102 and these structures together form the flow control system 1100.

In some embodiments, the inner surface 1114 of the inlet nozzle 1108 includes a structure 1116 that engages one or more of the orifice sockets 1102, such as to locate a first orifice socket 1102 in the correct position. Subsequent orifice sockets 1102 may be stacked upon the first orifice socket 1102 and the geometry of each orifice socket 1102 may position each orifice socket in the correct position to facilitate the desired pressure drop along the flow control system 1100. The structure 1116 may be a shelf, such as illustrated in FIG. 11B. Additional interfering structure may include a protrusion, a boss, a pin, a groove, a reduced diameter, or some other structure that may cooperate with a first orifice socket 1102 to position the same within the inlet nozzle 1108. In some cases, the outer surface of the orifice socket is in intimate contact with the inner surface of the inlet nozzle. In some cases, the tolerances between the orifice socket and the inlet nozzle are within 0.01″, or 0.005″, or smaller. In some cases, the structure inhibits flow leakage of primary coolant from between stacks.

By varying the geometry of the orifice sockets 1102 including the number, arrangement, and size of holes in the orifice sockets, the thermohydraulic characteristics of each flow control system 1100 may be varied to result in a simple to manufacture and assemble set of components that can be mixed and matched to produce any desired flow control parameters. In use, the orifice sockets 1102 can be arranged in an inlet nozzle for any core assembly, including without limitation, fissile fuel assemblies, fertile fuel assemblies, reflectors, neutron absorbers, neutron poisons, neutron shields, control rod assemblies, and others.

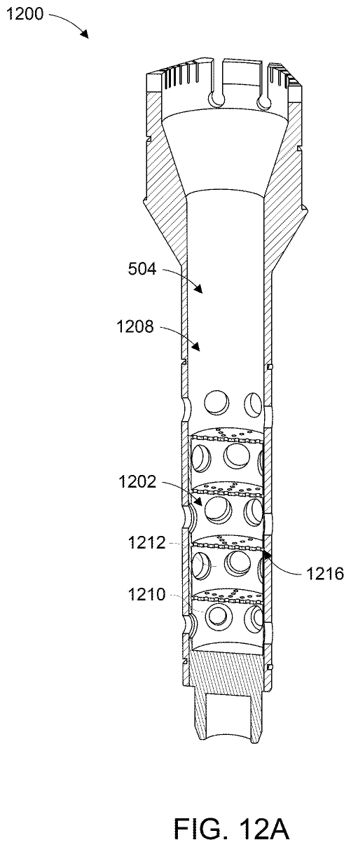

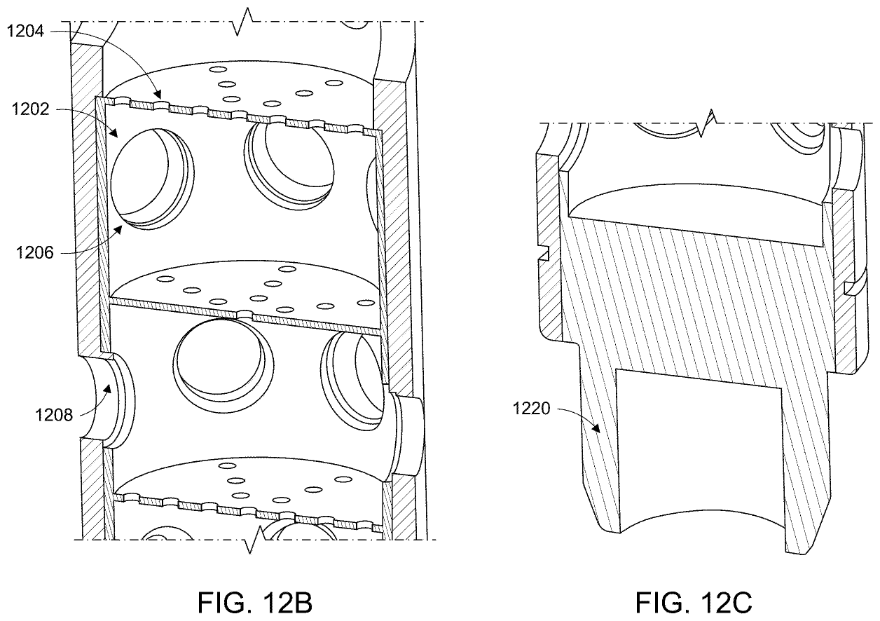

As illustrated in FIGS. 12A, 12B, and 12C components and embodiments of a sodium flow control device 1200 are illustrated. According to some embodiments, an orifice socket 1202 is a cup-shaped device having a circular top 1204 and a sidewall 1206 extending down from the top 1204. The top 1204 may be formed with one or more holes to allow primary coolant to flow therethrough. Similar to other embodiments described herein, the holes in the top 1204 of the orifice sockets 1202 may be sized and distributed to allow for a predetermined pressure drop across each orifice socket 1202 or across the entire flow stack 504. The sidewall 1206 may also have holes formed therein that may align with one or more holes in the inlet nozzle 1208 to allow sodium coolant to enter the flow stage defined by each respective orifice socket 1202. A series of orifice sockets 1202 may be stacked within the inlet nozzle 1208, such as by inserting the orifice sockets 1202 into the bottom of the inlet nozzle 1208 to control the pressure drop of the flow stack 504 and to provide one or more flow stages where coolant can enter the flow stack 504. The height of the sidewall 1206 may be configured to control the spacing between stacked orifice sockets 1202, such that each orifice socket 1202 defines a flow stage and each orifice socket top 1204 is spaced from adjacent orifice socket top 1204 a desired distance. In some examples, orifice sockets 1202 having different heights may be used to create flow stages having different volumes. For example, one or more first orifice sockets 1210 each having a first height may be stacked to create one or more flow stages. A second orifice socket 1212 having a second height larger than the first height may likewise be placed in the stack to create a flow stage having a larger volume than a flow stage volume created by the first orifice sockets. The orifice sockets 1202 may be arranged in any suitable configuration to create the flow characteristics desired by the flow control system 1200. In some cases, the inlet nozzle 1208 is configured to receive the orifice sockets 1202 and these structures together form the flow control system 1100.

In some embodiments, the inlet nozzle 1208 may have a step 1216 that engages a first orifice socket inserted into the inlet nozzle 1208, which locates the first orifice socket 1202 in the correct position. Subsequent orifice sockets 1202 may be stacked adjacent to the first orifice socket 1202 and the geometry of each orifice socket 1202 may position each orifice socket in the correct position to facilitate the desired pressure drop along the flow control system 1200. Additional interfering structure may be used in the alternative to a shelf 1216 and may include a protrusion, a boss, a pin, a groove, a reduced diameter, or some other structure that may cooperate with a first orifice socket 1202 to position the same within the inlet nozzle 1208. In some cases, the outer surface of the orifice socket is in intimate contact with the inner surface of the inlet nozzle. In some cases, the tolerances between the orifice socket and the inlet nozzle are within 0.01″, or 0.005″, or smaller. In some cases, the structure inhibits flow leakage of primary coolant from between stacks.

Subsequent orifice sockets may be inserted into the inlet nozzle until the desired number of orifice sockets are located within the inlet nozzle. A tip plug 1220 may be inserted into the inlet nozzle and secured through any suitable technique. In some cases, the tip plug 1220 is threaded into the inlet nozzle and may provide a compressive force against the orifice sockets to compress them together and secure them in place. In some cases, the tip plug 1220 may alternatively or additionally be welded in place.

By varying the geometry of the orifice sockets 1202 including the number, arrangement, and size of holes in the orifice sockets, the thermohydraulic characteristics of each flow control system 1200 may be varied to result in a simple to manufacture and assemble set of components that can be mixed and matched to produce any desired flow control parameters. In use, the orifice sockets 1202 can be arranged in an inlet nozzle for any core assembly, including without limitation, fissile fuel assemblies, fertile fuel assemblies, reflectors, neutron absorbers, neutron poisons, neutron shields, control rod assemblies, and others. In some embodiments, orifice sockets having different dimensions of volume, size of holes, and/or number of holes are used in different core assemblies to vary the thermohydraulic properties of selected core assemblies. In other words, the same arrangement of orifice sockets does not have to be used in each core assembly, but rather, different orifice sockets or configuration of orifice sockets can be used in different core assemblies.

The foregoing description of specific embodiments will so fully reveal the general nature of embodiments of the disclosure that others can, by applying knowledge of those of ordinary skill in the art, readily modify and/or adapt for various applications such specific embodiments, without undue experimentation, without departing from the general concept of embodiments of the disclosure. Therefore, such adaptation and modifications are intended to be within the meaning and range of equivalents of the disclosed embodiments, based on the teaching and guidance presented herein. The phraseology or terminology herein is for the purpose of description and not of limitation, such that the terminology or phraseology of the specification is to be interpreted by persons of ordinary skill in the relevant art in light of the teachings and guidance presented herein.

The breadth and scope of embodiments of the disclosure should not be limited by any of the above-described example embodiments, but should be defined only in accordance with the following claims and their equivalents.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

Unless otherwise noted, the terms “connected to” and “coupled to” (and their derivatives), as used in the specification, are to be construed as permitting both direct and indirect (i.e., via other elements or components) connection. In addition, the terms “a” or “an,” as used in the specification, are to be construed as meaning “at least one of” Finally, for ease of use, the terms “including” and “having” (and their derivatives), as used in the

The specification and annexed drawings disclose examples of systems, apparatus, devices, and techniques that may provide control and optimization of coolant flow through core assemblies. It is, of course, not possible to describe every conceivable combination of elements and/or methods for purposes of describing the various features of the disclosure, but those of ordinary skill in the art recognize that many further combinations and permutations of the disclosed features are possible. Accordingly, various modifications may be made to the disclosure without departing from the scope or spirit thereof. Further, other embodiments of the disclosure may be apparent from consideration of the specification and annexed drawings, and practice of disclosed embodiments as presented herein. Examples put forward in the specification and annexed drawings should be considered, in all respects, as illustrative and not restrictive. Although specific terms are employed herein, they are used in a generic and descriptive sense only, and not used for purposes of limitation.

From the foregoing, it will be appreciated that, although specific implementations have been described herein for purposes of illustration, various modifications may be made without deviating from the spirit and scope of the appended claims and the elements recited therein. In addition, while certain aspects are presented below in certain claim forms, the inventors contemplate the various aspects in any available claim form. For example, while only some aspects may currently be recited as being embodied in a particular configuration, other aspects may likewise be so embodied. Various modifications and changes may be made as would be obvious to a person skilled in the art having the benefit of this disclosure. It is intended to embrace all such modifications and changes and, accordingly, the above description is to be regarded in an illustrative rather than a restrictive sense.

What is claimed is:

1. An apparatus comprising: a core support structure;
a masking element defining at least one masking element opening disposed at a first height of the masking element, wherein the masking element is disposed on a first side of the core support structure; and
a flow stack configured to mate with the masking element, wherein the flow stack comprises:
a wall defining a plurality of flow stack inlets, wherein at least one of the plurality of flow stack inlets is configured to align with the at least one masking element opening when the flow stack is mated with the masking element; and
a flow control assembly disposed within the flow stack, wherein the flow control assembly comprises a plurality of spaced orifice plates configured to restrict a flow of fluid within the flow stack.

2. The apparatus of claim 1, wherein each plate of the plurality of orifice plates defines at least one orifice therethrough.

3. The apparatus of claim 2, wherein the flow stack comprises a height, and wherein the plurality of orifice plates are disposed at predetermined locations along the height, and wherein at least one of the plurality of flow stack inlets is disposed between each of the plurality of orifice plates.

4. The apparatus of claim 1, wherein a first flow stack inlet of the plurality of flow stack inlets comprises a diameter greater than a diameter of a second flow stack inlet of the plurality of flow stack inlets.

5. The apparatus of claim 1, wherein the flow control assembly comprises at least one labyrinthine element.

6. The apparatus of claim 5, wherein the at least one labyrinthine element is in fluidic communication with at least one of the plurality of flow stack inlets.

7. The apparatus of claim 1, wherein the flow control assembly comprises a filter.

8. The apparatus of claim 7, wherein the filter comprises a density that varies along a height of the flow stack.

9. The apparatus of claim 7, wherein the filter comprises a plurality of discrete filter elements.

10. The apparatus of claim 1, wherein the masking element is secured to the core support structure.

11. The apparatus of claim 1, wherein the core support structure is configured to receive an inlet guide pin secured to a core assembly in a position substantially aligned with the masking element.

12. The apparatus of claim 1, wherein the flow stack is connected to a fuel assembly, and wherein the flow stack is removable from the masking element upon lifting of the fuel assembly.

13. The apparatus of claim 1, wherein the masking element comprises a plurality of masking elements and wherein the flow stack comprises a plurality of flow stacks.

14. The apparatus of claim 13, wherein a first masking element defines a first masking element opening disposed at a first height of the first masking element, and wherein a second masking element defines a second masking element opening disposed at a second height of the second masking element, wherein the first height is greater than the first height.

15. The apparatus of claim 14, wherein the plurality of flow stacks are identical.

16. The apparatus of claim 1, wherein the flow stack wall comprises an outer housing and the outer housing defines an outlet at a first end of the outer housing.

17. The apparatus of claim 1, wherein the flow stack is disposed within the masking element when the flow stack is mated with the masking element.

18. The apparatus of claim 1, wherein the masking element is disposed within the flow stack when the flow stack is mated with the masking element.
